(19) United States
(12) Patent Application Publication
(10) Pub. No.: US 2008/0259617 A1
(43) Pub. Date: Oct. 23, 2008

(54) Transportation system and method or methods for the restoration,re-manufacturing and re-conditioning or any combination thereof,of a vehicle headlight fixture or headlight fixture lens or any combination thereof

(75) Inventors: Wayne M. Torcivia, Ronkonkoma, NY (US); Leonardo A. Santana, Ronkonkoma, NY (US)

Correspondence Address: MR. WAYNE M. TORCIVIA, 60 CREIGHTON AVE., RONKONKOMA, NY, 11779, US

(73) Assignee: WAYNE M. TORCIVIA

(21) Appl. No.: 11/787,949

(22) Filed: Apr. 19, 2007

(51) Int. Cl. B60Q 1/00

(52) U.S. Cl. 362/459; 451/42; 510/163

(57) ABSTRACT

A transportation system and method or methods for the restoration, re manufacturing, reconditioning or any combination thereof, a vehicle headlight fixture or vehicle headlight fixture lens; where the system is comprised of using any mode of transportation as a service, combined with or without the application of any method for the, restoration, re manufacturing, reconditioning or any combination thereof, on a vehicle headlight fixture or vehicle headlight fixture lens or any combination thereof, or any service for communicating the aforementioned system and method or methods or any combination thereof using any telecommunication configuration. This abstract is not to be considered limiting, since the embodiments may deviate from any content.

### CROSS REFERENCE

| Patent and Patent | | |
|---|---|---|
| Applications | Month & Year | Name |
| 3,659,307 | May 1972 | Vitou |
| 7,163,446 | January 2007 | Cole |
| 4,080,685 | March 1978 | Vander pool |
| 4,661,182 | April 1987 | Lerner |
| 5,248,521 | September 1993 | Yamane et al. |
| 5,443,604 | August 1995 | Stowell |
| 5,569,346 | October 1996 | Marshall |
| 6,001,793 | December 1999 | Figdore et al. |
| 6,244,707 | June 2001 | Faubl |
| 6,398,396 | June 2002 | Nestell et al |
| 6,428407 | August 2002 | Elder |
| 6,583,097 | June 2003 | Mcdonald |
| 6,6385,63 | October 2003 | Mcgee et al. |
| 6,831,049 | December 2004 | Torres Moreno |
| 6,846,567 | January 2005 | Ekinaka et al. |
| 6,855,210 | February 2005 | Dostic et al. |
| 6,984,612 | January 2006 | Maillie |
| 7,045,001 | May 2006 | Kropp et al. |
| 2003/0211962 | November 2003 | Held, 111 et al. |
| 2004/0121927 | June 2004 | Mcdonald |
| 2004/0157758 | August 2004 | Adickes |
| 2004/0235699 | November 2004 | Torres Moreno |
| 2006/0024427 | February 2006 | Clyde et al. |

### OTHER REFERENCES

1. Clearstar Coatings Corp., collection of screen shots from Internet—10 pages total, date unknown. Cited by other.
2. Material Safety Data Sheet for Brite Lites Lens Cleaner, two pages, date unknown. Cited by other.
3. “Brite Lites Plastic Lens Restorer”, five pages from Internet, date unknown. Cited by other.
4. Material Safety Data Sheet for Aqua-Buff 2000, two pages May 19, 1993. Cited by other.
5. Material Safety Data Sheet for Clearstar High Performance Gloss Clear Protective Coating, two pages, Aug. 16, 2001. Cited by other.
6. “Headlight Restoration Kits”, Details King' Supply Online Mall, three pages from Internet, GoEmerchant, 2003. Cited by other.
7. Crystal View Chemicals, Inc., “Directions For Headlight Restoration Kit”, two pages from Internet, 2004. Cited by other.
8. Lens Renew, “New Life For Your Plastic Headlight Lenses”, two pages from Internet, 2004. Cited by other.
9. Clearstar Coatings Corp., “Liquid Laminate Manual”, 13 pages, 2004. Cited by other.
10. Rightlook Automotive Reconditioning Equipment & Training, “Clearlights Headlight Restoration Kit”, two pages from Internet, 2005. Cited by other.

### RESEARCH AND DEVELOPMENT SPONSORSHIP STATEMENT

We have not received any financial support from any outside agent or agency towards the research and development of the device herein described. We have financed all the research and development of the the device herein described with our own funds.

### EXTERNAL REFERENCES

Refer to cross reference section.

### BACKGROUND OF THE INVENTION

As a vehicle that uses a headlight fixture or vehicle headlight fixture lens or any combination thereof, is exposed to any types of environmental conditions or wear & tear over time, the aesthetics, illumination efficiency, illumination projection efficiency for assisting of night vision operation is greatly diminished, and becomes a hazard for a vehicle operator, any passengers, pedestrians or any other vehicles who may come in contact with that vehicle that uses an inferior vehicle headlight fixture or vehicle headlight fixture lens or any combination thereof. There are an abundance of solutions offered to the public that are effective methods, products or cleaning systems for this existing hazard. The problem with these solutions, are they must be applied by the consumer, and are not user friendly, use hazardous chemicals, and are applied in most cases, in adverse environmental conditions rendering these products ineffective. And the desired outcome is never achieved allowing the hazard still to exist, subjecting themselves and others to a severe potential event involving personal injury, death, or property damage or any combination thereof, from decreased vehicle night vision operation. The solution to this problem is providing a diversified system and method as a service to the public combining any mode of transportation and any method for the restoration, re manufacturing, reconditioning or any combination thereof to a headlight fixture or vehicle headlight fixture lens or any combination thereof, in many diversified capacities. To achieve the desired outcome of improving the operation of a vehicle headlight fixture or vehicle headlight fixture lens or any combination thereof, thus eradicating the initial hazard of decreased vehicle night vision operation.

### BRIEF SUMMARY OF THE INVENTION

The invention is a transportation system and method or methods for the restoration, re-manufacturing, re-conditioning or any combination thereof, of a vehicle headlight fixture or headlight fixture lens or any combination thereof.

### DETAILED DESCRIPTION OF THE DRAWINGS

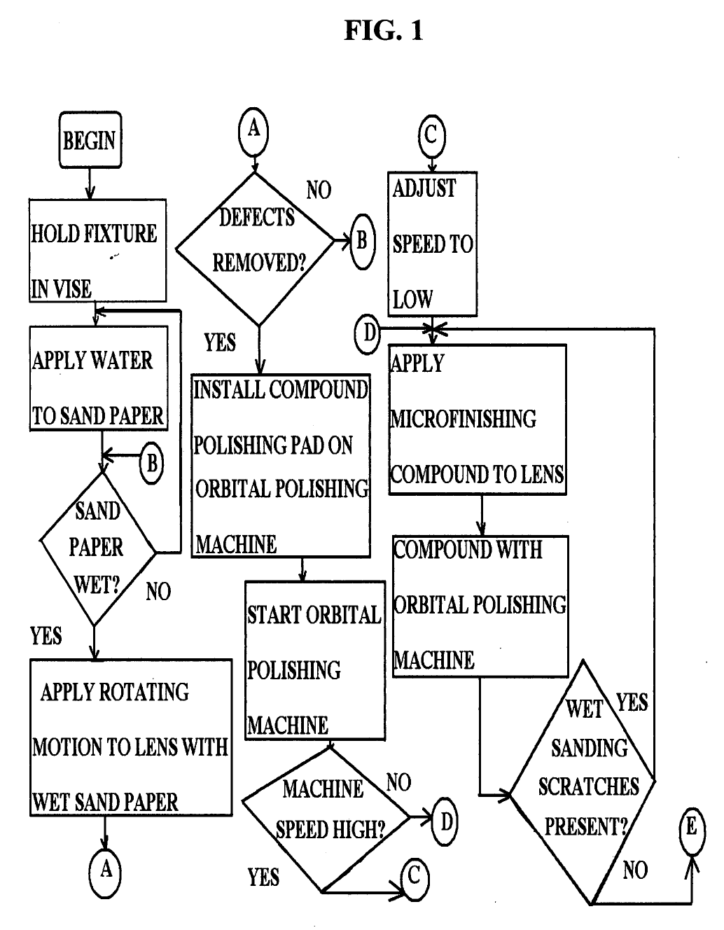

FIG. 1: MANUAL POLISHING PROCESS ALGORITHM PART ONE.

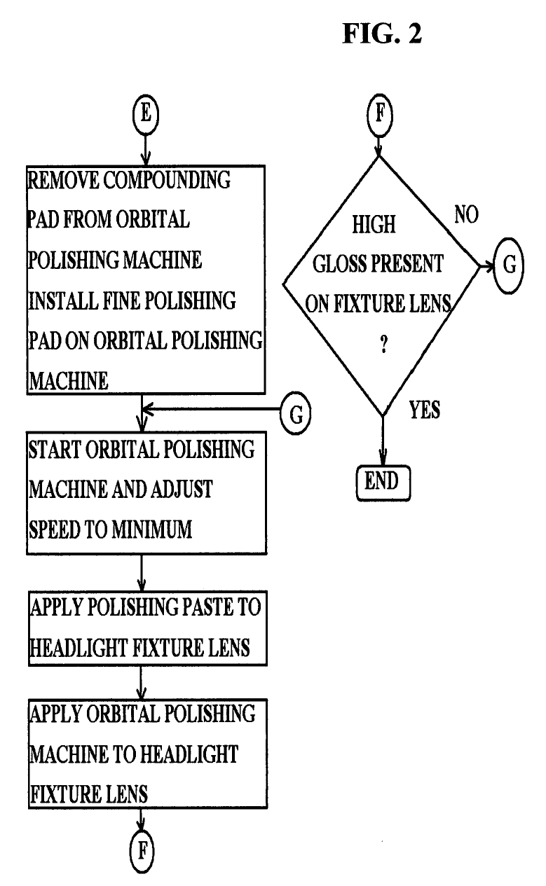

FIG. 2: MANUAL POLISHING PROCESS ALGORITHM PART TWO.

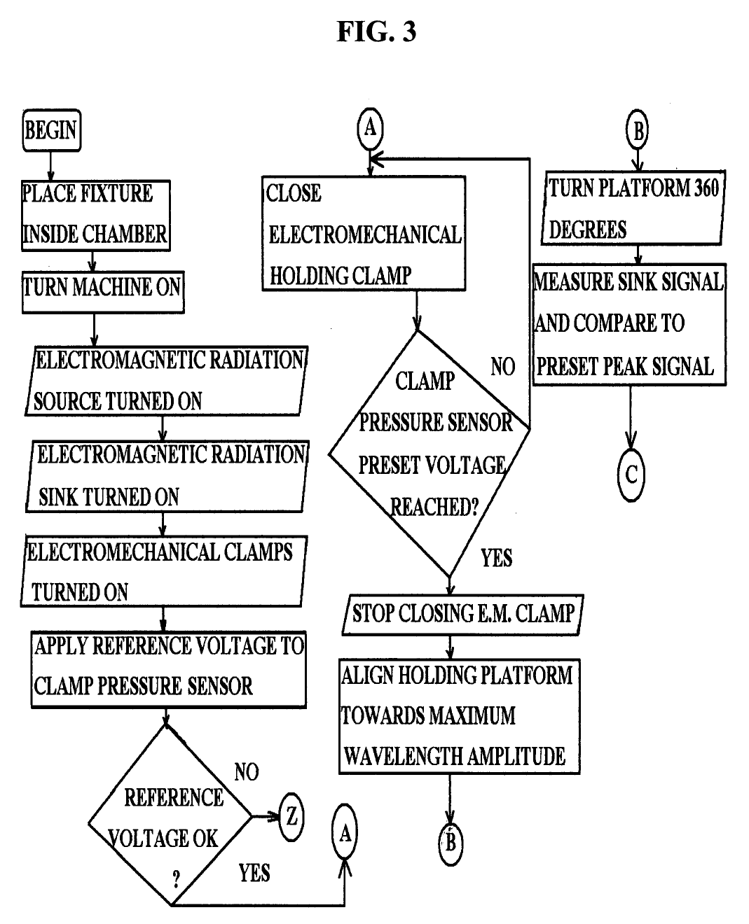

FIG. 3: AUTOMATED POLISHING PROCESS COMPUTER ALGORITHM FLOWCHART PART ONE.

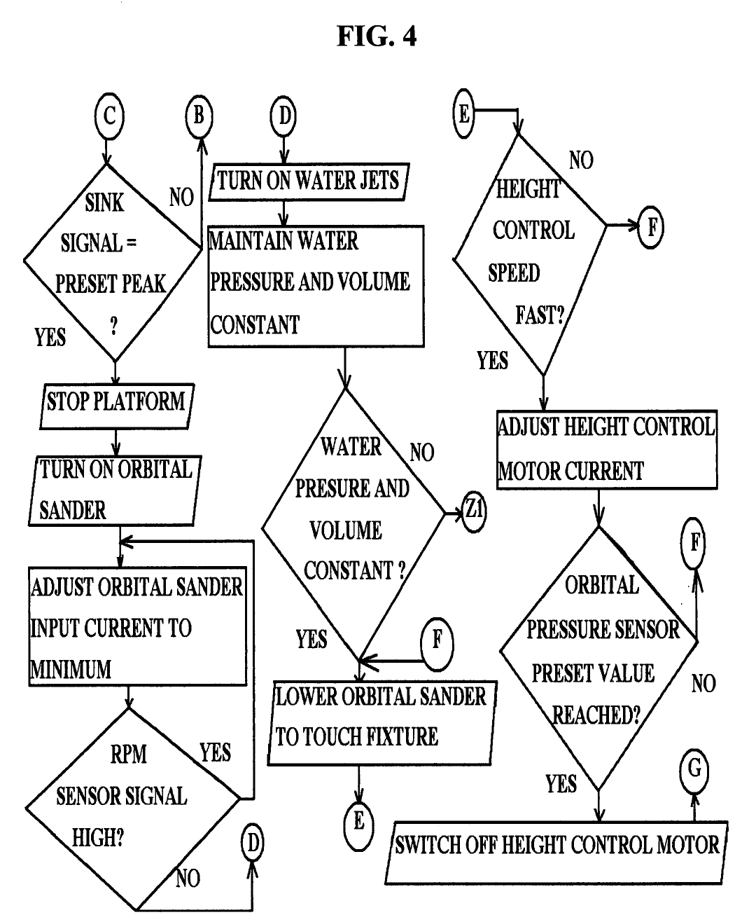

FIG. 4: AUTOMATED POLISHING PROCESS COMPUTER ALGORITHM FLOWCHART PART TWO.

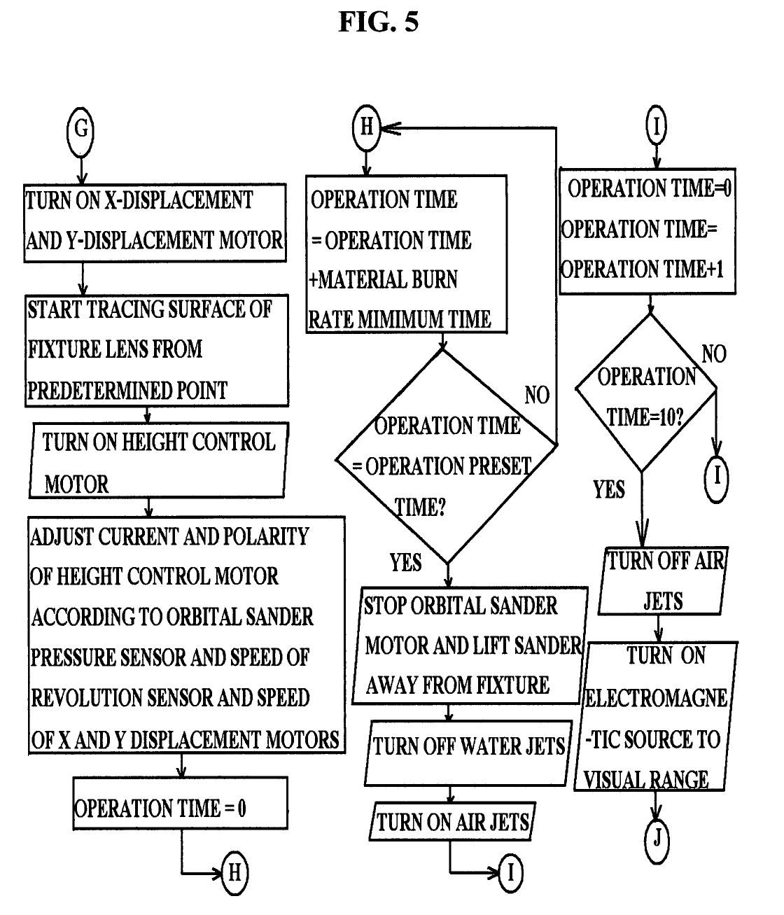

FIG. 5: AUTOMATED POLISHING PROCESS COMPUTER ALGORITHM FLOWCHART PART THREE.

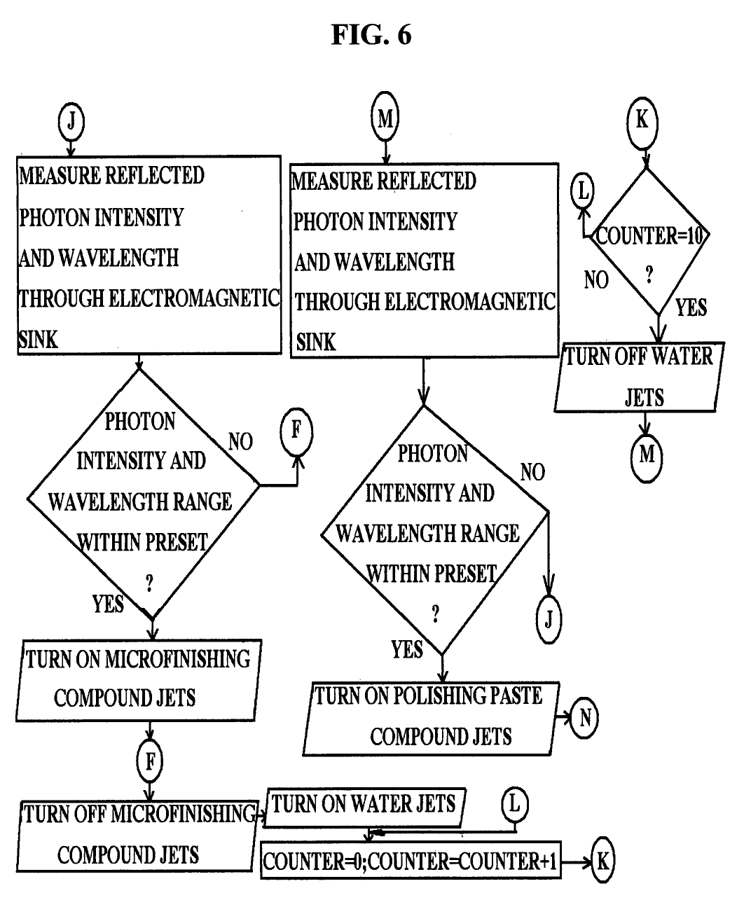

FIG. 6: AUTOMATED POLISHING PROCESS COMPUTER ALGORITHM FLOWCHART PART FOUR.

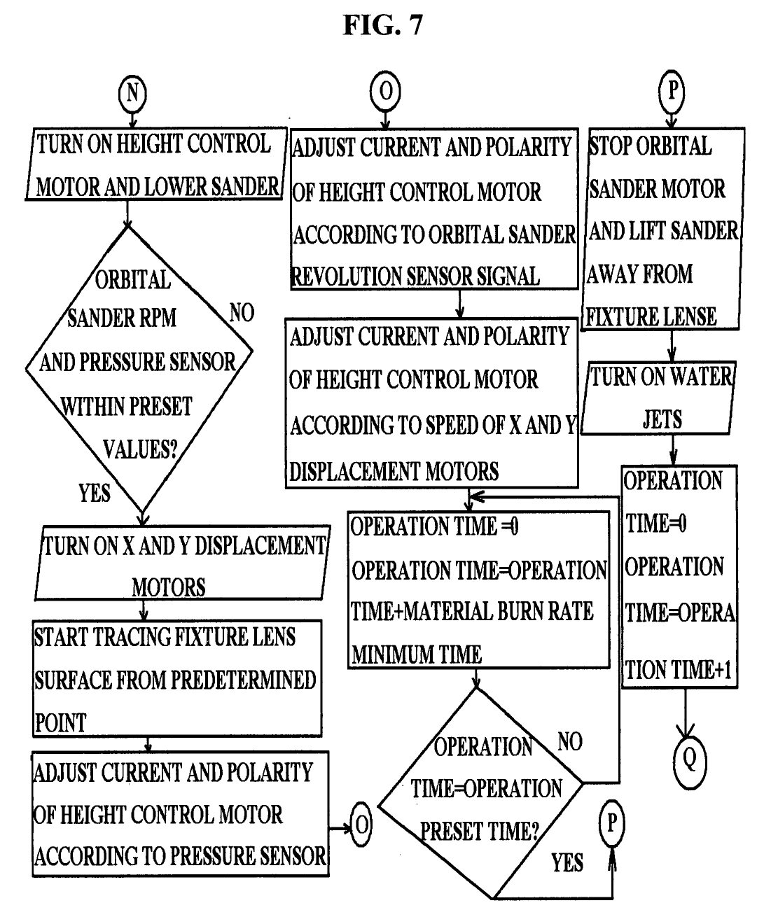

FIG. 7: AUTOMATED POLISHING PROCESS COMPUTER ALGORITHM FLOWCHART PART FIVE.

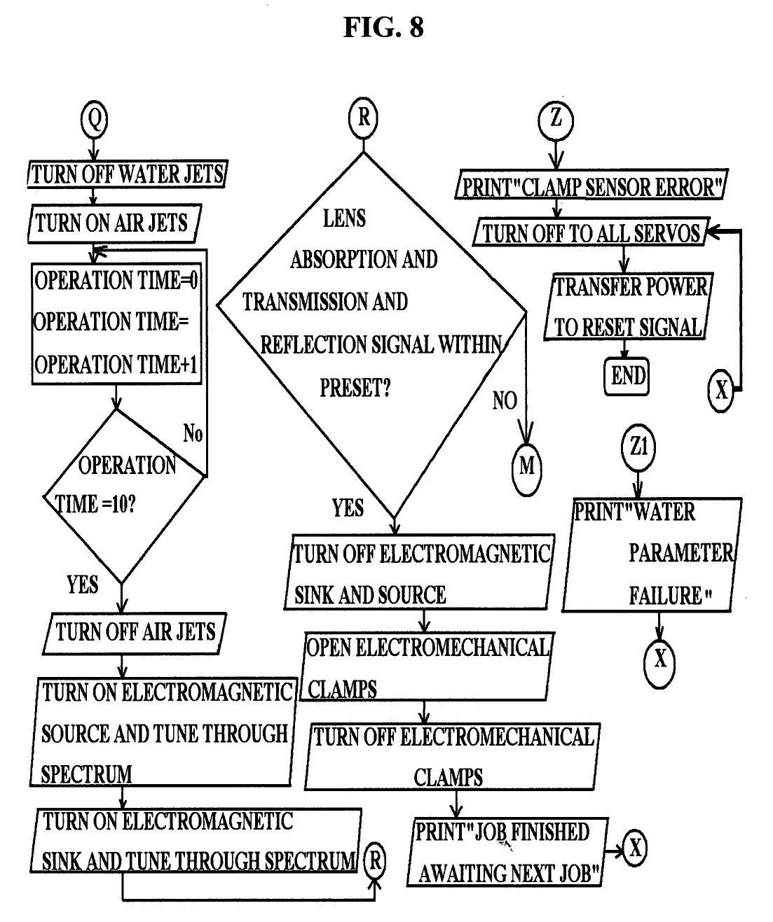

FIG. 8: AUTOMATED POLISHING PROCESS COMPUTER ALGORITHM FLOWCHART PART SIX.

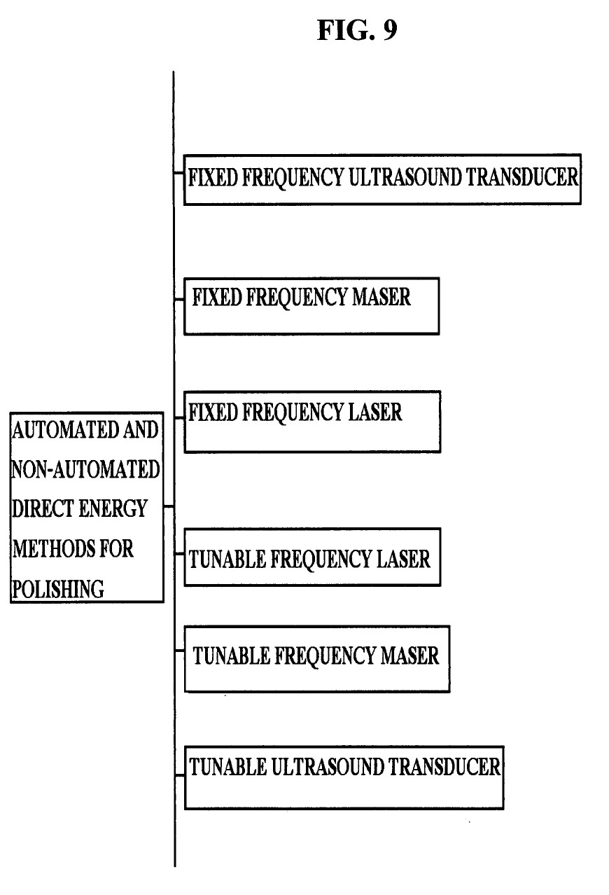

FIG. 9: AUTOMATED TUNED LASER/MASER/ULTRASOUND POLISHING PROCESS HIERARCHICAL CHART.

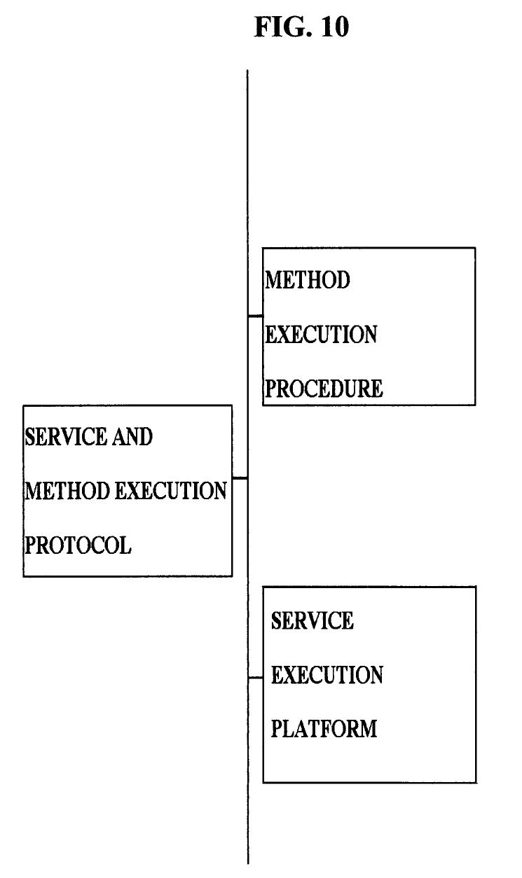

FIG. 10: SERVICE AND METHOD EXECUTION PROTOCOL HIERARCHICAL ORGANIZATION CHART.

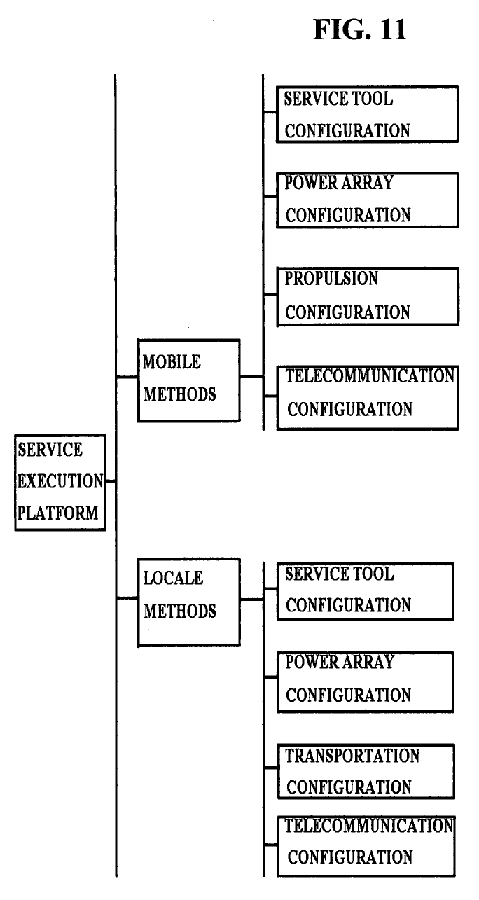

FIG. 11: SERVICE EXECUTION PLATFORM AND ASSOCIATED METHODS HIERARCHICAL ORGANIZATION CHART.

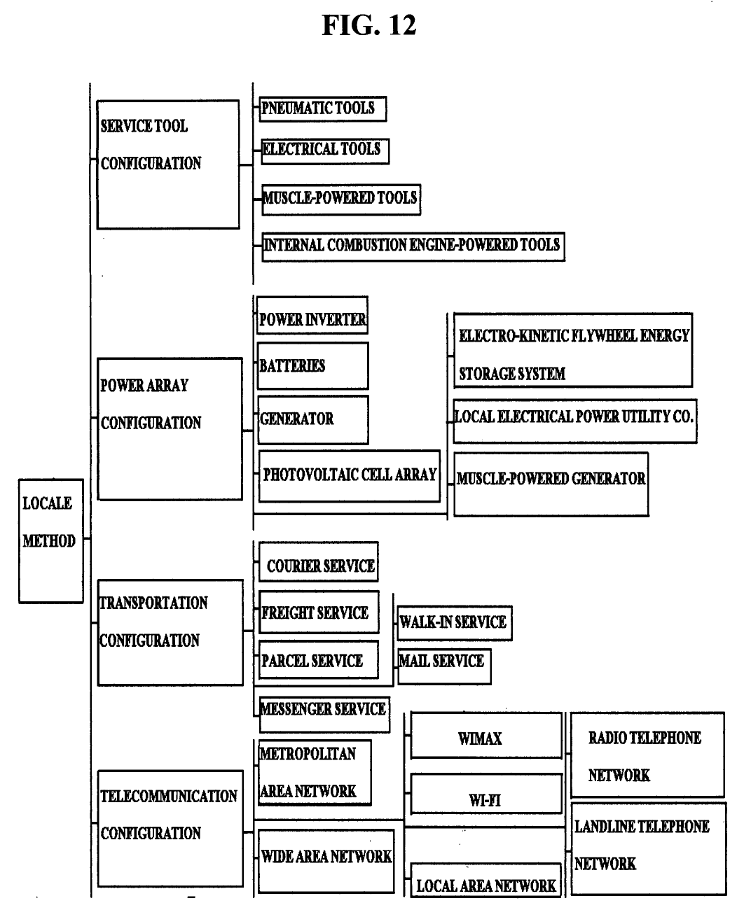

FIG. 12: SERVICE EXECUTION PLATFORM LOCALE METHODS HIERARCHICAL ORGANIZATION CHART.

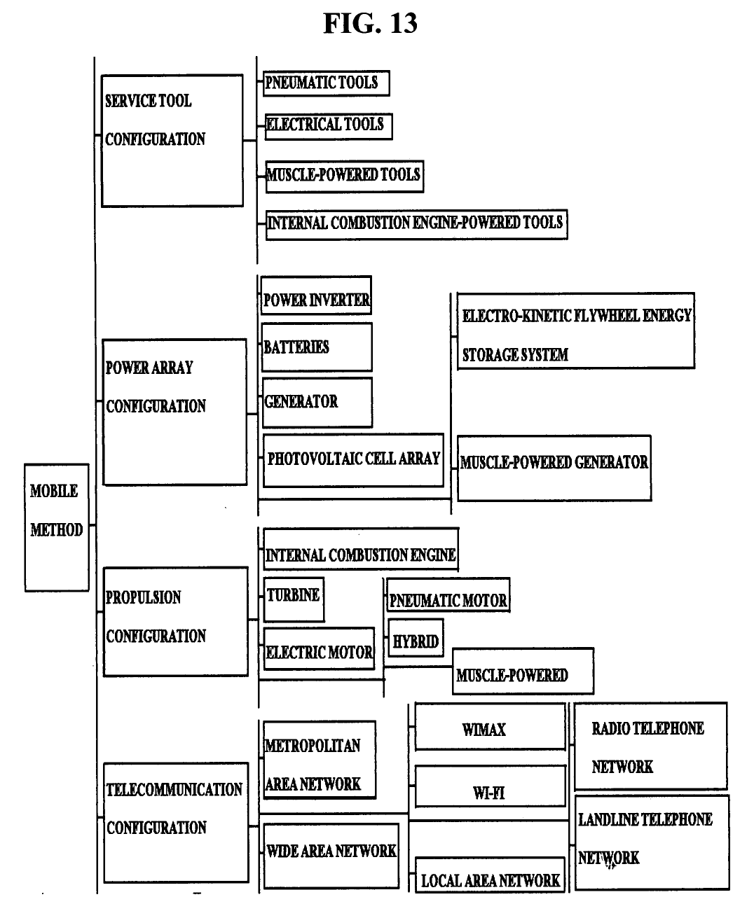

FIG. 13: SERVICE EXECUTION PLATFORM MOBILE METHODS HIERARCHICAL ORGANIZATION CHART.

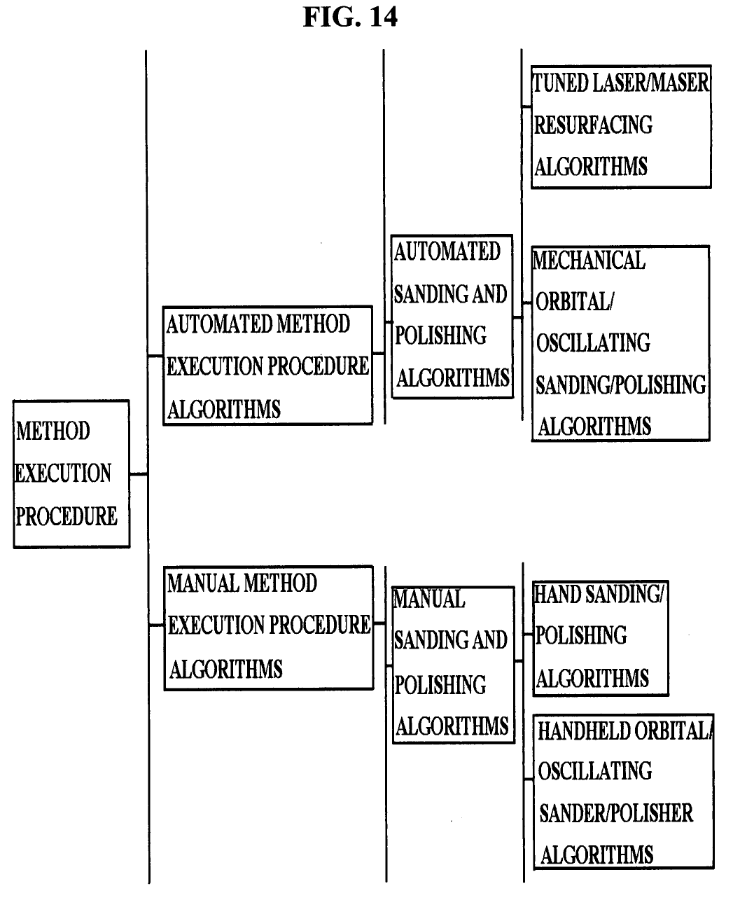

FIG. 14: METHOD EXECUTION PROCEDURE HIERARCHICAL ORGANIZATION CHART.

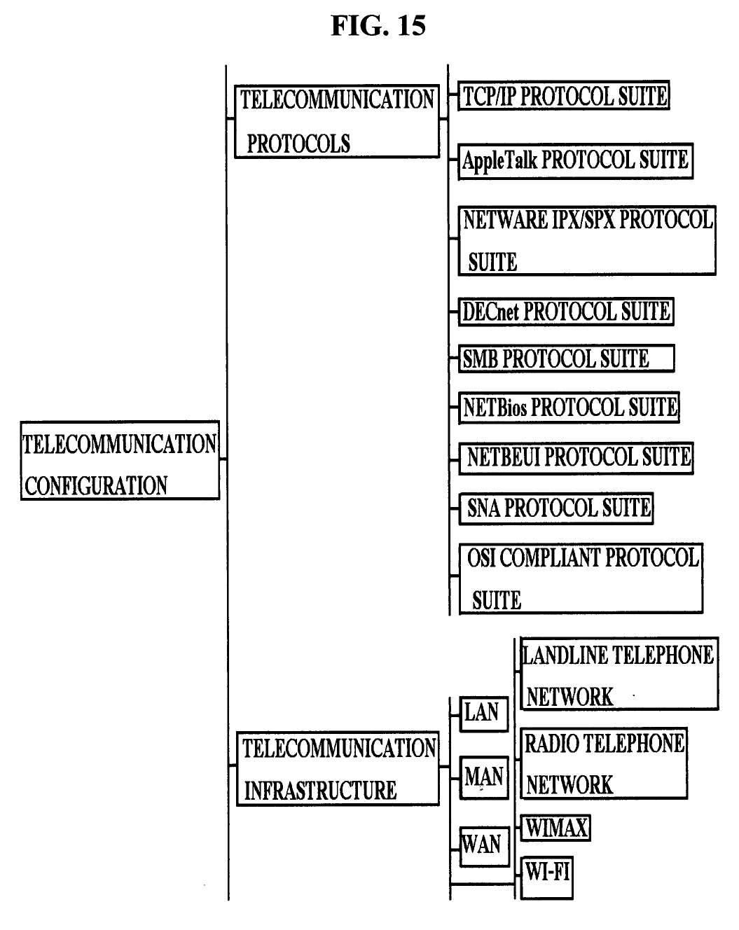

FIG. 15: TELECOMMUNICATION CONFIGURATION AND ASSOCIATED TELECOMMUNICATION PROTOCOLS HIERARCHICAL ORGANIZATION CHART.

### DETAILED DESCRIPTION OF THE INVENTION

Many vehicle manufacturers utilize a vehicle headlight fixture or vehicle headlight fixture lens or any combination thereof, for the purpose of expanding the designed function of a vehicles capacity to operate in an environment that requires a sufficient amount of light, projected from that vehicle in order to function in the vehicles full capacity. As a wide variety of vehicles possess a vehicle headlight fixture or vehicle headlight fixture lens for this purpose, the exposure to environmental conditions and wear & tear on a vehicle headlight fixture or vehicle headlight fixture lens or any combination thereof, present the problem of aesthetics, vehicle headlight fixture illumination and vehicle headlight fixture illumination projection, adversely affected and diminishing the operating capacity of a vehicle headlight fixture or vehicle headlight fixture lens or any combination thereof. There exists many system's, method or methods, or any combination thereof, for remedying this problem, and are very effective in eradicating this problem, but have no means of providing transportation for the transporting of a vehicle headlight fixture or vehicle headlight fixture lens or any combination thereof, to and from, on or away a location or any combination thereof, with or without applying any of these system's, method or methods or any combination thereof; on a vehicle headlight fixture or vehicle headlight fixture lens or any combination thereof; or applying any system, method or methods, or any combination thereof; on a vehicle headlight fixture or vehicle headlight fixture lens or any combination thereof; to and from, or on or away a location, on a vehicle that possess a vehicle headlight fixture or vehicle headlight fixture lens or any combination thereof, using a vehicle as the primary transportation and platform combined with the necessary tools and equipment and materials for applying a system, method or methods, to and from, or on or away from a location, or any combination thereof, with or without the removal of the vehicle headlight fixture or vehicle headlight fixture lens or any combination thereof; from a vehicle, or the use of a telecommunications configuration as a component combined with any system, method or methods or any combination thereof, using the vehicle, tools and equipment as a whole operating service, for eradicating this problem. The solution for this problem is the Transportation system and method or methods for the re manufacturing, reconditioning of a vehicle headlight fixture or vehicle headlight fixture lens or any combination thereof. Where one of the many embodiments used for the Transportation system and method or methods for the restoration, re manufacturing, re conditioning of a vehicle headlight fixture or vehicle headlight fixture lens or any combination thereof, is comprised of transporting a vehicle headlight fixture or vehicle headlight fixture lens or any combination thereof; to and from a location, on or away from a location or any combination thereof; using a, an, any, or any combination thereof; a mail service; comprised of a courier service, a freight service, a messenger service, using any one or any combination thereof; a courier service, comprised of; a mail service, a freight service, a messenger service, using any one or any combination thereof; a freight service; comprised of a mail service, courier service, messenger service, using one or any or any combination thereof; a messenger service; comprised of a mail service, freight service, courier service using one or any combination thereof; using one or any combination thereof; of the aforementioned services, for shipping and receiving or any combination thereof; of a vehicle headlight fixture or headlight fixture lens or any combination thereof; to and from or on and away a location, or with or without applying any system, method or methods, related or unrelated to a vehicle headlight fixture or headlight fixture lens or any combination thereof; for the restoration, re manufacturing, reconditioning of a vehicle headlight fixture or vehicle headlight fixture lens or any combination thereof; for improving the aesthetics, vehicle headlight fixture illumination and vehicle headlight fixture illumination projection, as the desired outcome, and incorporated with the Transportation system and method and methods for the restoration, re manufacturing, reconditioning of a vehicle headlight fixture or vehicle headlight fixture lens or any combination thereof; combined as a whole. Or using a vehicle as the primary transportation and platform combined with the tools and equipment, incorporated with the Transportation system and method and methods for the restoration, re manufacturing, reconditioning of a vehicle headlight fixture or vehicle headlight fixture lens or any combination thereof; operating as a whole, for applying a system, method or methods, related or unrelated to a vehicle headlight fixture or headlight fixture lens or any combination thereof; for the restoration, re manufacturing, re conditioning on a vehicle headlight fixture or vehicle headlight fixture lens or any combination thereof; to and from or on or away from a location, or any combination thereof; and with or without the removal of the vehicle headlight fixture or vehicle headlight fixture lens or any combination thereof; from a vehicle, to achieve the aforementioned desired outcome. Wherein the vehicle, platform, tools and equipment, may vary due to different configurations, and is comprised of using a, an, any, or any combination thereof; in a stationary or mobile capacity, a van; used in a mobile capacity as the transportation and platform, equipt with the tools and equipment combined as a whole, and incorporated into the Transportation system and method or methods for the restoration, re manufacturing, reconditioning of a vehicle headlight fixture or vehicle headlight fixture lens or any combination thereof, a box truck; used in a mobile capacity as the transportation and platform, equipt with the tools and equipment combined as a whole, and incorporated into the Transportation system and method or methods for the restoration, re manufacturing, re conditioning of a vehicle headlight fixture or vehicle headlight fixture lens or any combination thereof, a pickup truck; used in a mobile capacity as the transportation and platform, equipt with the tools and equipment combined as a whole, and incorporated into the Transportation system and method or methods for the restoration, re manufacturing, reconditioning of a vehicle headlight fixture or vehicle headlight fixture lens or any combination thereof, a flatbed truck; used in a mobile capacity as the transportation and platform equipt with the tools and equipment combined as a whole, and incorporated into the Transportation system and method or methods for the restoration, re manufacturing, reconditioning of a vehicle headlight fixture or vehicle headlight fixture lens or any combination thereof, a flatbed truck; used in a mobile capacity as the transportation and platform equipt with the tools and equipment combined as a whole, and incorporated into the Transportation system and method or methods for the restoration, re manufacturing, reconditioning of a vehicle headlight fixture or vehicle headlight fixture lens or any combination thereof; an automobile, used in a mobile capacity as the transportation and platform equipt with the tools and equipment combined as a whole, and incorporated into the Transportation system and method or methods for the restoration, re manufacturing, reconditioning of a vehicle headlight fixture or vehicle headlight fixture lens or any combination thereof. The vehicle's on board equipment is mounted stationary to the platform or carried by the platform, depending on the transporting vehicle's platform configuration, and is comprised of using a, an, any, or any combination thereof; a generator, gasoline or electric operated, used mounted stationary on the platform, or in a mobile capacity, as an a/c electrical source, an air compressor; gasoline or electric operated, used mounted stationary on the platform, or in a mobile capacity, as a source for compressed air for operating any pneumatic equipment, a power inverter; in combination with a battery's as an a/c electrical power source, with or without mounting the power inverter stationary against the passenger side; rear side wall in the vehicle, depending on the transporting vehicle's platform configuration, a 12v battery, 's or any combination thereof, with or without mounting the battery's inside the vehicle against the passenger side; rear side wall, depending on the transporting vehicle's platform configuration, and is used in combination with the power inverter as an a/c electrical power source, an outside power source, comprised of a building in the vicinity using a/c electric power utilities as a source of power, an electrical extension cord 100 ft length, 50 ft length, 25 ft length, 10 ft length, using any one or combination thereof; used to connect to the primary power source, for operating any electrically driven equipment, an oscillating, an orbital, a pneumatic type, or a/c or d/c electrically operated variable speed, sanding or polishing machine using one or any combination thereof; used for compound polishing, wet sanding, final finish polishing using any one or any combination thereof, a box of 25 sheets of 3M 1500, 1000, 600, 400, grit wet sanding paper or any combination thereof, for the removal of oxidation or minute scratches, from a vehicle headlight fixture or vehicle headlight fixture lens or any combination thereof, a micro finishing compound, using a paste or liquid type, or any combination thereof, used for the removal of scratches caused by the wet sanding process, a final finish polish; paste or liquid or any combination thereof, used for removing very fine compounding scratches, a 2, 4, 6, 8, 10 inch diameter polishing pad, used in combination with any one or any combination thereof; oscillating, orbital, pneumatic type, or a/c or d/c or any combination thereof; for the removal of fine compounding scratches, an 8 oz squeeze bottle filled with water; for applying water to wet sanding paper at a location; for the wet sanding process, a laptop computer; equipped for Internet access, for receiving or sending information via e mail to a customer's or a manufacture, a cell phone; used for communicating to a potential customer's or a manufacturer. Provided herein, is one of the many embodiments for the application of a method or methods for the restoration, re manufacturing, reconditioning of a vehicle headlight fixture or vehicle headlight fixture lens or any combination thereof; this application for the restoration, re manufacturing, reconditioning of a vehicle headlight fixture or vehicle headlight fixture lens or any combination thereof; is applied without the removal of the vehicle headlight fixture from the vehicle. Proceeding with the first step, using a van, equipt with the necessary tools and equipment as the preferred vehicle and platform of choice for applying a method for the restoration of a vehicle headlight fixture lens for this particular application, comprised of a, an, any, or any combination thereof; a gasoline operated mobile generator, an orbital type high or low speed a/c electrically operated polishing machine, a 100 ft a/c electrical cord, a sheet of 1500 grit wet sanding paper, an 8 oz squeeze bottle filled with water, an 8 oz bottle of 3M liquid micro finishing compound, an 8 oz bottle of 3M final finish liquid polish. Using one sheet of the 1500 grit wet sand paper, in combination with the squeeze bottle of water, apply a generous amount of water on to the sheet of wet sanding paper; always keeping the wet sanding paper wet and never allowing to dry. Using the saturated wet sanding paper, apply a rotating type motion against the oxidized vehicle headlight fixture lens until all oxidation or minute scratches present have been removed. Once this procedure has been accomplished, proceed to the next step, by removing the gasoline operated generator from the van, starting and plugging your 100 ft extension cord into the generator, and in turn; plugging in your orbital high and low speed polisher into the receiving end of the extension cord, in the same process installing the 6 inch compound polishing pad to the a/c electrically operated orbital type polishing machine. Proceed to start the orbital polishing machine, adjusting the speed to the lowest setting, while applying 4 dime size drops of the 3M micro finishing compound on to the vehicle headlight fixture lens; and starting the compounding process by applying your orbital type polishing machine; equipped with the 6 inch compounding pad to the vehicle headlight fixture lens, applying compound as needed to remove the fine wet sanding scratches away, until a clear scratch free appearance is achieved. At this point remove the compounding pad from the orbital polishing machine, and install on your orbital polishing machine the fine polishing pad, repeating the prior step, and replacing the micro finishing compound with the 3M polishing paste, polishing until a high gloss is achieved on the vehicle headlight lens, thus; completing one method of restoration of a vehicle headlight fixture lens. The Transportation system and method or methods for the restoration, re manufacturing, reconditioning, or any combination thereof, is described in itemized detail contained herein as follows; the Transportation system is comprised of any mode of transportation, used as a method for the transporting of a vehicle headlight fixture lens or any combination thereof; as a service, with or with out applying a method or methods or any combination for the restoration, re manufacturing, reconditioning, or any combination thereof; on a vehicle headlight fixture or vehicle headlight fixture lens, to and from, or on and away from a location or any combination thereof, or as a transportation service and method or methods for the restoration, re manufacturing, reconditioning, or any combination thereof; on a vehicle that possess a vehicle headlight fixture or vehicle headlight fixture lens, to and from, or on or away from a location or any combination thereof, with or without the removal of the vehicle headlight fixture or vehicle headlight fixture lens or any combination thereof, or a telecommunications network as used as a component of The transportation system and method or methods for the restoration, re manufacturing, reconditioning, or any combination thereof; as defined as section (1): Vehicles specified as a mode for transportation using a, an or any, or any combination thereof, (a) an automobile, (b) a truck, (c) a train, (d) an airplane, (e) a marine vessel, (f) a motorcycle, (g) a bicycle, (h) any one subsection or any combination thereof, described in section (1). As defined as section (2): Methods of a Vehicle propulsion using a, an, or any, or any combination thereof, (1a) an internal combustion engine, using a fuel for combustion comprising of, gasoline, alcohol, diesel, propane, natural gas, electric, (2b) a fuel cell, comprised of any fuel or any combination thereof; of subsection (1a), in section (2), (3c) electric motor comprised of a battery's using one or any combination thereof, of sub section (2b) in section (2), (4d) a turbine engine comprised of using jet fuel, or any one or any combination thereof; of subsection (1a), of section (2), (5e) a solar powered motor; using sunlight or manufactured method for producing the necessary light illuminated for the operation of the motor (6f) a hybrid engine comprised of; using one or any combination thereof; of subsection's, (1a), (2b), (3c) in section (2), (7g) a human powered propulsion comprised of; walking or pedaling. As described as section (3): Modes of service, method or methods for the transporting of a vehicle headlight fixture or vehicle headlight fixture lens or any combination thereof; using a, an, any, any combination thereof (1aa) a courier service, (2bb) a freight service, (3cc) a parcel service, (4dd) a messenger service, (5ee) using any one or any combination thereof of subsection's (1aa), (2bb), (3cc) in section (3). As described as section (4): Modes of a telecommunication configurations, used as a component combined with the transportation system and method or methods or any combination thereof combination thereof; for the re manufacturing, reconditioning of a vehicle headlight fixture or vehicle headlight fixture lens or any combination thereof; using a, an, any, or any combination thereof (1aaa) an Internet service, (2bbb) a wireless telecommunication service, (3ccc) a land line telephone network service, (4ddd) a fiber optic television transmission network system, (5eee) a satellite television transmission network system, (6fff) a terrestrial radio transmission network system, (7ggg) a short wave radio transmission network system, (8hhh) a portable satellite radio transmission network system, (9iii) a portable satellite computer transmission network system, (10jjj) a two way radio transmission system (11kkk) a vehicle on board satellite computer transmission network (12lll) a stationary computer using a fiber optics network system, (13mmm)a telephone fiber optic network system (14nnn) a cable television transmission network system (15ooo) a fiber optic telephone network system (16ppp) using any one or any combination thereof; of subsection's (1aaa), (2bbb), (3ccc), (4ddd), (5eee), (6fff), (7ggg), (8hhh), (9iii), (10jjj), (11kkk), (12lll), (13mmm), (14nnn), (15ooo), in section (3). As described as section (4) Other system, method, methods related or unrelated, using one or any combination thereof; to a vehicle headlight fixture or vehicle headlight fixture lens or any combination thereof; for the restoration, re manufacturing, reconditioning, or any combination thereof; to achieve the same outcome of improving the aesthetics, vehicle headlight fixture illumination and vehicle headlight fixture illumination projection or any combination thereof; comprised of using one or any combination thereof; of the cited Patent or Patent application numbers, and other references that apply contained in the Cross Reference section.

### CROSS REFERENCE BETWEEN WRITTEN DESCRIPTION AND FIGURES

Section 1: Vehicles specified as a mode for transportation with subsections (a),(b),(c),(d),(e),(f),(g) and (h) or any combination, thereof; refer to FIG. 10, FIG. 11 and FIG. 13.
Section 2: Methods of a vehicle propulsion using any combination of (1a),(2b),(3c),(4d),(5e),(6f) and (7g) or any combination, thereof; refer to FIG. 10, FIG. 11, FIG. 13.
Section 3: Modes of service, method or methods for the transporting of a vehicle headlight fixture or vehicle headlight fixture lens or any combination thereof; using any particular subsection (1 a a), (2 b b),(3 c c),(4 d d),(5 e e) or any combination, thereof; refer to FIG. 10, FIG. 11, FIG. 12 and FIG. 13.
Section 4: Modes of a telecommunication configurations, used as a component combined with the transportation system and method or methods or any combination thereof combination thereof; for the re manufacturing, reconditioning of a vehicle headlight fixture or vehicle headlight fixture lens or any combination thereof; using any particular subsection (1 a a a),(2 b b b),(3 c c c),(4 d d d),(5 e e e),(6 f f f),(7 g g g), (8 h h h), (9 i i i),( 10 j j j),(11k k k),(12 lll),(13 m m m),(14 n n n),(15 o o o) and (16 p p p) or any combination, thereof; refer to FIG. 10, FIG. 11, FIG. 12 and FIG. 15.

For all other method execution procedures and implementation descriptions refer to FIGS. 1, 2, 3, 4, 5, 6, 7, 8, 9, and 14.

What is claimed is:

1. A transportation system and method or methods for the restoration, re manufacturing, re conditioning or any combination thereof, of a vehicle headlight fixture or vehicle headlight fixture lens or any combination thereof; comprised of a system using any mode of transportation or service or any combination thereof; (1) with or without transporting a vehicle headlight fixture or vehicle headlight fixture lens or any combination thereof; (2) with or without applying on a vehicle headlight fixture or vehicle headlight fixture lens or any combination thereof; any system, method or methods for the restoration, re manufacturing, re conditioning or any combination thereof; related or unrelated to a vehicle headlight fixture or vehicle headlight fixture lens or any combination thereof; to improve the aesthetics, illumination efficiency and illumination projection efficiency or any combination thereof; (3) using any system, method or methods or any combination thereof; for the restoration, re manufacturing, re conditioning or any combination thereof; related or unrelated to a vehicle headlight fixture or vehicle headlight fixture lens or any combination thereof; to improve the aesthetics, illumination efficiency and illumination projection efficiency or any combination thereof; on a vehicle that possesses a vehicle headlight fixture or vehicle headlight fixture lens or any combination thereof, with or with out removing the vehicle headlight fixture or vehicle headlight fixture lens or any combination thereof; from a vehicle, and using any telecommunication configuration, as a main component of the Transportation system and method or methods for the restoration, re manufacturing, reconditioning or any combination thereof, of a vehicle headlight fixture or vehicle headlight fixture lens or any combination thereof; using one or any combination thereof; aforementioned procedures, (1), (2), (3), combined with any mode of transportation or service, or any combination thereof; and combined with any telecommunication configuration as a whole; wherein, any system, method or methods for the restoration, re manufacturing, reconditioning or any combination thereof; related or unrelated to a vehicle headlight fixture or vehicle headlight fixture lens, or any combination thereof, is applied on a vehicle headlight fixture or vehicle headlight fixture lens or any combination thereof; to improve the aesthetics, illumination efficiency and illumination projection efficiency or any combination thereof, as the final outcome.
